(19) United States
(12) Patent Application Publication
(10) Pub. No.: US 2017/0237640 A1
(43) Pub. Date: Aug. 17, 2017

(54) SYSTEM AND METHOD FOR CORRELATING CAPTURED NETWORK PACKET WITH METADATA

(71) Applicant: BARRACUDA NETWORKS, INC., Campbell, CA (US)

(72) Inventor: Matthias Stocker, Muhlen in Taufers (IT)

(21) Appl. No.: 15/263,927

(22) Filed: Sep. 13, 2016

Related U.S. Application Data
(60) Provisional application No. 62/294,275, filed on Feb. 11, 2016.

(51) Int. Cl. H04L 12/26; G06F 17/30

(52) U.S. Cl. CPC H04L 43/0876; G06F 17/30876

(57) ABSTRACT

A new approach is proposed that contemplates system and method to support correlating captured network traffic going through a network appliance with its metadata for troubleshooting and debugging of the network traffic. First, network traffic in the form of data packets are captured and filtered for metadata based on user-specified parameters. A correlation is then established between the captured data packets and the metadata in a chronologically correct fashion. The metadata is then integrated and stored with the captured network packets in a correlated network traffic database in a standard storage format, which can later be retrieved for visualization, debugging and tracing of program flows and other data with respect to the network traffic through the network appliance.

### CROSS-REFERENCE TO RELATED APPLICATIONS

This application claims the benefit of U.S. Provisional Patent Application No. 62/294,275, filed Feb. 11, 2016, and entitled “Network packet capture with correlated meta-data,” which is incorporated herein in its entirety by reference.

### BACKGROUND

When analyzing issues or program flows in general of network traffic through network appliances such as firewalls and gateways, a user often needs to collect and analyze both metadata, which includes but is not limited to runtime network packet tracing information, and the network packets through the network appliances for troubleshooting. Since both types of information are only available separately, the correlation of the tracing information, or any other types of metadata, and the actual network traffic is very difficult and may not even be possible when the network traffic rate is very high.

A network traffic analyzer such as Wireshark adopts for non-limiting examples, packet capture (PCAP) or PCAP Next Generation Dump File Format (PCAP-NG) to store network traffic for later visualization in a viewer. Here, the PCAP typically includes an application programming interface (API) for capturing network traffic. Although PCAP-NG offers some mechanism to insert metadata into files of the captured network traffic for later analysis, there is no mechanism to establish a correlation between the network traffic and the metadata on program flows through the network appliances. It is thus desirable that the next generation network appliances are able to not only create PCAP files from the captured network traffic, but also to correlate the captured network traffic with tracing information and/or other types of metadata accordingly.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system diagram to support correlating captured network packet with metadata in accordance with some embodiments.

FIG. 2 depicts an example of various components of the metadata correlating engine running on the host in accordance with some embodiments.

FIG. 3 depicts a flowchart of an example of a process to support correlating captured network packet with metadata in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach is proposed that contemplates system and method to support correlating captured network traffic going through a network appliance with its metadata for troubleshooting and debugging of the network traffic. First, network traffic in the form of data packets are captured and filtered for metadata based on a plurality of user-specified parameters. A correlation is then established between the captured data packets and the metadata in a chronologically correct fashion. The metadata is then integrated and stored with the captured network packets in a correlated network traffic database in a standard storage format, which can later be retrieved by the user for visualization, debugging and tracing of program flows and other data with respect to the network traffic through the network appliance.

In the discussions below, PCAP file storage/output format, which is supported by many libraries and applications, is used as a non-limiting example of a standard storage format for storage of the captured network traffic data. A person ordinarily skilled in the art would understand that the same approach is also applicable to another file format (not limited to PCAP) for storing the captured data.

The proposed approach provides an easy and reliable way to debug the network traffic by correlating runtime tracing information and other metadata of the network packets with actual network packets captured. By providing a faster and simpler correlation capabilities between the network traffic and its metadata, the proposed approach makes the network appliance such as a firewall, more versatile for finding and troubleshooting anomalies in the network. Since the proposed approach stores metadata with specific network packets rather than in annotation fields, it can also be used with the standard PCAP format without modification. Additionally, the proposed approach provides an infrastructure for adding metadata in a chronological order, unlike PCAP-NG.

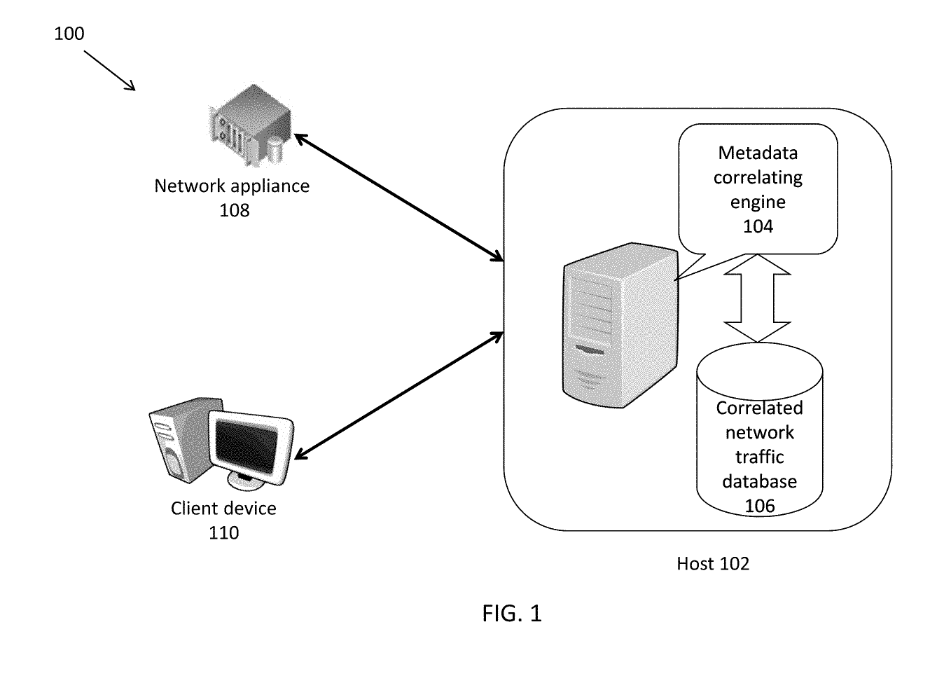

FIG. 1 depicts an example of a diagram of system 100 to support correlating captured network packet with metadata. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes at least metadata correlating engine 104 and correlated network traffic database 106, each running on a computing unit/appliance/host 102 with software instructions stored in a storage unit such as a non-volatile memory (also referred to as secondary memory) of the computing unit for practicing one or more processes. When the software instructions are executed, at least a subset of the software instructions is loaded into memory (also referred to as primary memory) by one of the computing units of the computing unit, which becomes a special purposed one for practicing the processes. The processes may also be at least partially embodied in the host into which computer program code is loaded and/or executed, such that, the host becomes a special purpose computing unit for practicing the processes. When implemented on a general-purpose computing unit, the computer program code segments configure the computing unit to create specific logic circuits.

In the example of FIG. 1, the host 102 can be a computing device, a communication device, a storage device, or any computing device capable of running a software component. For non-limiting examples, a computing device can be but is not limited to a laptop PC, a desktop PC, a tablet PC, or an x86 or ARM-based a server running Linux or other operating systems.

In the example of FIG. 1, network appliance 108 is a hardware-based, software-programmable networking device that generates network traffic in the form of network data packets, wherein the network appliance 108 may include a firewall that can be programmed and configured by software at runtime. Here, the network appliance 108 can be but is not limited to an x86 or ARM based device with multiple wireless and/or Ethernet interfaces. In some embodiments, the network appliance 102 can be a multi-core embedded hardware module/processor or a single System-on-Chip (SoC) chip comprising one or more of coprocessors (not shown), a memory (also referred to as primary memory, not shown) such as RAM, and a storage unit (not shown) such as a non-volatile memory (also referred to as secondary memory) with software instructions stored in for practicing one or more processes.

In some embodiments, the host 102 has a communication interface (not shown), which enables the metadata correlating engine 104 and the correlated network traffic database 106 running on the host 102 to communicate with the network appliance 108 and a client device 110 following certain communication protocols, such as TCP/IP, http, https, ftp, and sftp protocols, over one or more communication networks (not shown). Here, the client device 110 is utilized by a client to view, analyze, and debug metadata-correlated network traffic, wherein the client devices reside either locally or remotely (e.g., in a cloud) from the host 102. As shown in the example of FIG. 1, the client device 110 can be but is not limited to, mobile/hand-held devices, PCs, and server machines. The communication networks can be but are not limited to, internet, intranet, wide area network (WAN), local area network (LAN), wireless network, Bluetooth, WiFi, and mobile communication network. The physical connections of the network and the communication protocols are well known to those of skill in the art.

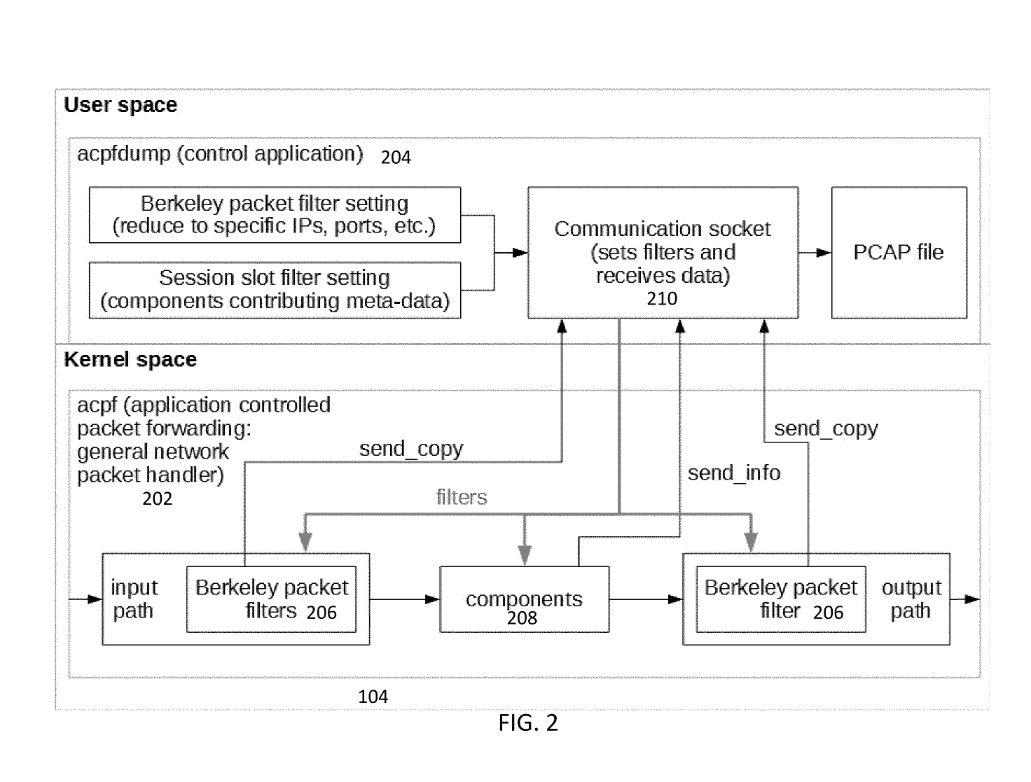

In the example of FIG. 1, the metadata correlating engine 104 is configured to capture a plurality of network data packets from the network appliance 108, filter metadata from the captured network data packets, chronologically correlate the metadata with the network data packets, and save the metadata-correlated network data packets in the correlated network traffic database 106. FIG. 2 depicts an example of various components of the metadata correlating engine 104 running on the host 102. As shown by the example of FIG. 2, the metadata correlating engine 104 comprises an network packet handler 202 running in the kernel space of the OS of the host 102 for application-controlled packet capturing and forwarding (acpf) and a control application 204 running in the user space of the OS of the host 102 for control of the network packet handler 202 and saving/dumping of the metadata-correlated network packets (acpfdump) to the correlated network traffic database 106.

In some embodiments, the network packet handler 202 is configured to capture a plurality of network data packets and their metadata (such as program flow related data) via a programming library designed for the use with any network related kernel module. Specifically, when network packet capturing is triggered, the data packets and the metadata from the network appliance 108 are captured and filtered by one or more packet filters 206 (e.g., Berkeley packet filters) and/or metadata filtering components 208, respectively, based on the parameters (e.g., firewall rules) specified via the control application 204 by the user. The packet filters 206 and the components 208 then transfer a copy of the captured network packets and the metadata to a special local communication socket 210 in the user space, which is used as a minimal overhead communication interface between the network packet handler 202 in the kernel space and the control application 204 in the user space. Alternatively, a copy of the captured network packets and metadata can be sent to a remote UDP socket to a service (not shown).

In some embodiments, the control application 204 is configured to interact with a user for configuration and control of the network packet handler 202 via a command line tool. Specifically, the control application 204 is configured to compile and set various user-specified parameters/settings of the packet filters 206 and components 208 for packet capturing and metadata filtering in the kernel space via the communication socket 210. In some embodiments, the parameters are compiled into an structure (e.g., tcpdump style) that can efficiently be used by the network packet handler 202 in the kernel space. Here, the user-specified parameters define exactly which network traffic to analyze by the packet filters 206 and which kind of metadata for the components 208 to add and correlate to the network traffic if applicable. For non-limiting examples, the packet capturing parameters include but are not limited to specific IPs and/or ports of the incoming network packets and metadata, and the metadata filtering parameters include but are not limited to session slot settings to filter components 208 in the network traffic that contribute to the metadata.

In some embodiments, the control application 204 is configured to listen to the special local communication socket 210 (or remote socket) for incoming network packets and/or metadata from the network appliance 108 as defined by the filter settings. Once the network packets and/or metadata are captured by the packet filters 206 and the components 208, respectively, the control application 204 is then configured to received, correlate and interleave the network packets (e.g., send_copy) and metadata (e.g., send_info) captured in a chronological order. The control application 204 is also configured to write the network packet data and the metadata to a specified PCAP file to the correlated network traffic database 106 as-is (e.g., in raw data format) and/or with a summary of the network packets and metadata information back to the user at the client device 110.

In some embodiments, a specific (e.g., layer 2) communication protocol is adopted by the communication socket 210 for communication between the network packet handler 202 and the control application 204, which includes setting the parameters of the packet filters 206 and transferring wrapped network packets and metadata back to the control application 204.

In some embodiments, the packet filters 206 such as such as Berkeley packet filters are implemented to match the network traffic against specified filter criteria for each input path and/or output path of the network appliance 108. In some embodiments, one packet filter 206 can be placed at one single location along the input path and another packet filter 206 can be placed at a location along the output path as shown by the example of FIG. 2. Here, each packet filter 206 captures and filters the network packet based on user-specified parameters for packet filtering, which for non-limiting example, can limit network traffic to between specified source IPs and ports and specified destination IPs and ports including complete network IP and/or port ranges. If one or more matching network packets are found, the packet filters 206 would trigger a callback (e.g., send_copy), which copies and extends/wraps/encapsulates the network packet with the appropriate header and transfers it to the local communication socket 210 (or a remote UDP socket). In some embodiments, the header is a Layer 2 specific (pseudo) protocol header (or a Layer 3 pseudo header if PCAP is used to collect information). Such header is required to differentiate and later visualize the metadata encapsulated in the network packet by the user at the client device 110 via network analyzing tools such as Wireshark with a LUA protocol dissector script added as a plugin. In some embodiments, the control application 204 is configured to inject additional metadata into the captured unencrypted network packet via the local communication socket 210.

In some embodiments, when a network session is created, one or more corresponding session slot filter settings are specified by the control application 204 and stored in components 208 along with the session information for metadata filtering. The components 208 is then configured to match the session slot filter settings with the network packets to identify the metadata and send the identified metadata to the local communication socket 210 via, for example, a send_info callback function.

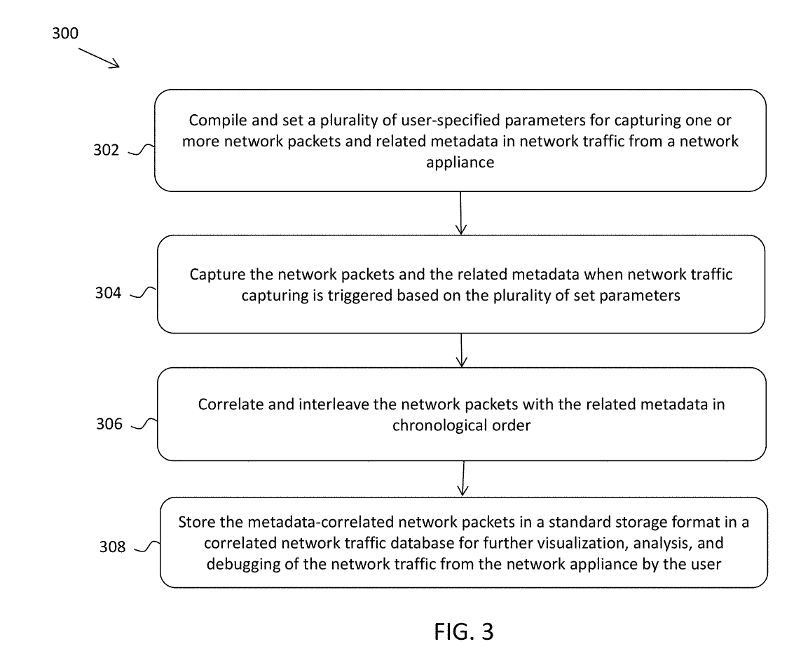

FIG. 3 depicts a flowchart 300 of an example of a process to support correlating captured network packet with metadata. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways.

In the example of FIG. 3, the flowchart 300 starts at block 302, where a plurality of parameters are compiled and set for capturing one or more network packets and related metadata in network traffic from a network appliance. The flowchart 300 continues to block 304, where the network packets and the related metadata are captured when network traffic capturing is triggered based on the plurality of set parameters. The flowchart 300 continues to block 306, where the network packets are correlated and interleaved with the related metadata in chronological order. The flowchart 300 continues to block 308, where the metadata-correlated network packets are stored in a standard storage format in a correlated network traffic database for further visualization, analysis, and debugging of the network traffic from the network appliance.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system to support correlating captured network packet with metadata, comprising:
a metadata correlating engine running on a host, which in operation, is configured to
compile and set a plurality of user-specified parameters for capturing one or more network packets and related metadata in network traffic from a network appliance;
capture the network packets and the related metadata when network traffic capturing is triggered based on the plurality of set parameters;
correlate and interleave the network packets with the related metadata in chronological order;
store the metadata-correlated network packets in a standard storage format in a correlated network traffic database for further visualization, analysis, and debugging of the network traffic from the network appliance by the user;
said correlated network traffic database running on the host, which in operation, is configured to maintain the metadata-correlated network packets in a standard storage format for further visualization, analysis, and debugging.

2. The system of claim 1, wherein:
the network appliance is a hardware-based, software-programmable networking device that includes a firewall configurable by software at runtime.

3. The system of claim 1, wherein:
the metadata includes runtime program flow and tracing information of the network packets.

4. The system of claim 1, wherein:
the standard storage format is packet capture (PCAP) or PCAP Next Generation Dump File Format (PCAP-NG).

5. The system of claim 1, wherein:
the metadata correlating engine is configured to store the metadata with the network packets outside of annotation fields without requiring any modification to the standard storage format.

6. The system of claim 1, wherein:
the metadata correlating engine comprises
an network packet handler running in kernel space of operating system (OS) of the host configured to capture and forward the network packets and the metadata; and
a control application running in user space of the OS of the host configured to control the network packet handler and correlate and save the metadata-correlated network packets to the correlated network traffic database.

7. The system of claim 6, wherein:
the network packet handler is configured to transfer a copy of the captured network packets and the metadata to a special local communication socket in the user space, wherein the local communication socket is a minimal overhead communication interface between the network packet handler in the kernel space and the control application in the user space.

8. The system of claim 6, wherein:
the network packet handler is configured to transfer a copy of the captured network packets and the metadata to a remote UDP socket to a service.

9. The system of claim 6, wherein:
the control application is configured to compile and set the user-specified parameters for packet capturing and metadata filtering into an structure that is used by the network packet handler in the kernel space.

10. The system of claim 7, wherein:
the control application is configured to listen to the special local communication socket for the incoming network packets and/or metadata from the network appliance as captured based on the user-specified parameters.

11. The system of claim 7, wherein:
the control application is configured to inject additional metadata into the captured network packet via the local communication socket.

12. The system of claim 7, wherein:
the network packet handler is configured to copy and wrap the network packets with a header and transfers it to the local communication socket if one or more matching network packets are found and a callback is triggered.

13. The system of claim 12, wherein:
the header is a Layer 2 pseudo protocol header required to differentiate and visualize the metadata wrapped in the network packets by the user via network analyzing tools with a protocol dissector script added as a plugin.

14. The system of claim 12, wherein:
the special local communication socket is configured to adopt a specific communication protocol for communication between the network packet handler and the control application, including setting the parameters of the network packet handler and transferring the wrapped network packets and metadata back to the control application.

15. The system of claim 1, wherein:
the user-specified parameters limit network traffic to between specified source IPs and ports and specified destination IPs and ports including complete network IP and/or port ranges.

16. The system of claim 1, wherein:
the user-specified parameters include one or more corresponding session slot filter settings when a current session is created, wherein session slot filter settings are matched with the network packets to identify the metadata for metadata filtering.

17. A method to support correlating captured network packet with metadata, comprising:
compiling and setting a plurality of user-specified parameters for capturing one or more network packets and related metadata in network traffic from a network appliance;
capturing the network packets and the related metadata when network traffic capturing is triggered based on the plurality of set parameters;
correlating and interleaving the network packets with the related metadata in chronological order;
storing the metadata-correlated network packets in a standard storage format in a correlated network traffic database for further visualization, analysis, and debugging of the network traffic from the network appliance by the user.

18. The method of claim 17, further comprising:
storing the metadata with the network packets outside of annotation fields without requiring any modification to the standard storage format.

19. The method of claim 17, further comprising:
capturing and forwarding the network packets and the metadata via an network packet handler running in kernel space of operating system (OS) of the host;
controlling the network packet handler and correlating and saving the metadata-correlated network packets to the correlated network traffic database via a control application running in user space of the OS of the host.

20. The method of claim 19, further comprising:
transferring a copy of the captured network packets and the metadata to a special local communication socket in the user space, wherein the local communication socket is a minimal overhead communication interface between the network packet handler in the kernel space and the control application in the user space.

21. The method of claim 19, further comprising:
transferring a copy of the captured network packets and the metadata to a remote UDP socket to a service.

22. The method of claim 19, further comprising:
compiling and setting the user-specified parameters for packet capturing and metadata filtering into an structure that is used by the network packet handler in the kernel space.

23. The method of claim 20, further comprising:
listening to the special local communication socket for the incoming network packets and/or metadata from the network appliance as captured based on the user-specified parameters.

24. The method of claim 20, further comprising:
injecting additional metadata into the captured network packet via the local communication socket.

25. The method of claim 20, further comprising:
copying and wrapping the network packets with a header and transfers it to the local communication socket if one or more matching network packets are found and a callback is triggered, wherein the header is a Layer 2 pseudo protocol header.

26. The method of claim 25, further comprising:
differentiating and visualizing the metadata wrapped in the network packets by the user via network analyzing tools with a protocol dissector script added as a plugin.

27. The method of claim 25, further comprising:
adopting a specific communication protocol for communication between the network packet handler and the control application, including setting the parameters of the network packet handler and transferring the wrapped network packets and metadata back to the control application.
